(19) United States
(12) Patent Application Publication
(10) Pub. No.: US 2010/0115757 A1
(43) Pub. Date: May 13, 2010

(54) DEVICE AND METHOD FOR PRODUCING AN ORTHOPAEDIC AID, AND CORRESPONDING AIDS

(76) Inventor: Bernhard Sacherer, Friesenheim (DE)

Correspondence Address: EGBERT LAW OFFICES, 412 MAIN STREET, 7TH FLOOR, HOUSTON, TX, 77002, US

(21) Appl. No.: 12/523,518

(22) PCT Filed: Jan. 28, 2008
(86) PCT No.: PCT/EP08/00638

§ 371 Date: Jan. 4, 2010

(30) Foreign Application Priority Data
Jan. 31, 2007 (DE) 10 2007 005 648.8

(51) Int. Cl. B23P 25/00; B23P 19/00

(52) U.S. Cl. 29/458; 29/700

(57) ABSTRACT

The invention relates to a device and a method for producing a orthopaedic aid. In order to precisely adapt an orthopaedic aid, it is necessary, on the body part intended to correspond to the orthopaedic aid, to take into account, during preparation of the orthopaedic aid, the displacements of muscle and other tissue that occur when the finished aid is used under loading. To avoid the hitherto lengthy adaptation procedure, a device is proposed that has a plurality of interconnected shaped parts connected to a main frame via holders that can be fixed in their position. By means of these shaped parts, it is possible to generate a spatial supporting surface and to alter it as required in order to support a body part with realistic loading an accordingly realistic tissue displacement. The resulting shape can be utilized to produce a corresponding orthopaedic aid.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC Not applicable.

### BACKGROUND OF THE INVENTION

1. Field of the Invention

The invention concerns a device for producing an individually adapted orthopedic device, such as a prosthetic shank or an orthesis, as well as a corresponding method for producing the orthopedic device and a corresponding orthopedic aid.

2. Description of Related Art Including Information Disclosed Under 37 CFR 1.97 and 37 CFR 1.98.

It is known in the art, for the manufacture of an individual orthopedic aid, as for instance a prosthetic shank or an orthesis, how to produce a negative mold of the corresponding body part of a person. The problem with this is that the mold of the orthopedic aid should be adapted to the shape of the body or body part as it presents itself under loading where tissue is deformed due to displacement, compression etc. Here it is necessary to take into account for instance that in the example of a thigh stump the end of the thigh bone is usually at a distance of between 1 and 8 cm from the distal stump end and that the stump end proper thus consists of muscle and other tissue which is correspondingly deformable. Also, movements that are performed for instance with a prosthesis result in alterations of the osseous and/or muscular relief which is meant to correspond with the orthopedic aid.

On the other hand, a person with an artificial limb for instance must not experience any pressure points which could lead, for example with diabetics, to necrotic manifestations.

Much experience and intuition is required of an orthopedic mechanic so that he is able to anticipate the appropriate relief alterations on the basis of mass and volume displacements on the unloaded body part. The fact is that the adaptation of an appropriate orthopedic aid still remains a time-consuming and labor-intensive process of trial and error with frequently only suboptimal results. Within the scope of the fitting process repeated reworking of molds and models becomes necessary before a definitive shape is found for an aid.

With the methods used until now, initially the relevant masses of muscle are displaced, for instance manually for the creation of a negative mold. But this allows only a limited loading on a body part and neither is it certain whether the manually simulated forces correspond to the actually occurring loads.

But it has already been proposed and attempted to measure relevant body portions by extremely varied imaging or similar methods of representation and to simulate the displacements of mass to be expected under loading on the basis of empirical experience in a computer. With the resulting data it is then possible to create, by means of computer-assisted machines, three-dimensional models of, for instance, a loaded stump which then serve as the basis for the manufacture of an appropriate orthopedic aid.

In spite of these expensive methods for producing a working model, for the orthopedic mechanic, these known methods of process result in initial versions of orthopedic aids which eventually cause unpleasant sensations of pressure in the users and which fail to achieve the desired close fit. It is then up to the orthopedic mechanic to optimize the model at hand by adding or removing material which again assumes considerable experience and continues to rely on the trial and error principle. It is also problematic that any modifications made cannot be immediately evaluated in their effects, as in particular a direct before/after comparison is not possible. Until an aid is being produced that in its fitting form satisfies the wishes of the user and other requirements such as pressure loading only in non-critical regions with few vessels and/or nerves, several steps of iteration may be necessary.

For every step of iteration the aid has to be removed and be re-attached after modifications have been made, being a time-consuming and stressful process not only for the person wearing the artificial limb but also for the orthopedic mechanic

Especially with older or weakened persons such a procedure does not take place in an orthopedic workshop but must be performed in situ with these persons, whereas most modifications on the model or on the aid produced from the model can only be made using shop equipment which entails transportation and other additional costs for the orthopedic mechanic

### BRIEF SUMMARY OF THE INVENTION

The aim of the present invention is therefore to indicate a device and a method for producing an orthopedic aid which allow the production of such an aid in a more timely and well-fitting manner.

According to the invention, this problem is solved by providing an appropriate device which features a number of interconnected shaped parts which are joined by supports to a base frame, with the supports being able to be modified in their position, i.e. their situation in space and if necessary, in their shape and to be fastened in a definitive manner.

The essential advantage of the invention lies therefore in the fact that by means of the number of interconnected shaped parts a spatial support area can be created which is being supported through said holders by a base frame, so that it is possible to support a body part by the shaped parts with a load approaching reality. The shaped parts hence need to be worn directly on the body with a load approaching reality and are adjustable. At the same time a realistic tissue displacement is being achieved. The shaped parts can also be made to follow this tissue displacement in a very precise way until a uniform and/or comfortable fit is achieved for the person with the artificial limb. In this position, the supports of the shaped parts are eventually fixed so that in this manner the position of the shaped part supported by the corresponding support is also fixed.

Then after the person with the artificial limb has detached his stump from the device, the shaped parts remain in the position in which they were fixed and describe a definitive negative mold of the body part under loading, such as the stump for instance. This resulting complete and definitive functional form can be used to shape the model of a loaded body part from which an orthopedic aid is produced in the usual manner. Since the functional form was already picked up under load and in a statically optimized position, no further costly iterative steps are needed for fitting an aid produced from this model. Particularly for the determination of the functional form all modifications and adjustments are made directly on the body without detaching the aid, like a prosthesis for instance.

This mold can also be used as a model for the production of a mostly finished scan file in order to manufacture a model according to the known methods.

While it is well within the scope of the invention when the shaped parts are interconnected only indirectly by means of the supports and/or base frame, preferably the shaped parts are interconnected in a way where they are adjustable against each other. For this purpose it is especially proposed to execute the shaped parts so they overlap each other and to allow appropriate fastening against each other by means of conveniently placed oblong holes or slots capable of accepting adjustable attachment screws.

Here it is also possible to provide special shaped parts, such as ramus and trochanter implants on a thigh prosthesis by which a prosthesis shank is fitted especially to the bone relief of a prosthesis-wearing person. It is planned to keep these special shaped parts independent of the other shaped parts, so that any modification of the other shaped parts does not result in an undesirable misadjustment of corresponding fixed points which are represented by the special shaped parts.

The supports by which the shaped parts are fastened to the base frame are adjustable in their length and/or their spatial location by means of appropriately clamped sliding connections or other articulations or hinges. For the sake of good form it is also mentioned here that it is also within the scope of the invention, if the connection of a support to the base frame is done only indirectly, that is to say for instance by intercalation of an additional support.

Since the supports are adjustable, there exists for instance the possibility to slide against each other or within themselves, by means of these supports, a plurality of shaped parts forming essentially a circle, so they assume an oval shape that is oriented towards the body in any desirable way. It is also possible to incline, twist or distort the shaped parts together or individually, so that the support area resulting inside the aid, for instance for a leg stump, becomes modified and is adapted to the requirements of the prosthesis -bearing person. Thus there exists the possibility, to not only take into consideration the actual situation of the soft tissue defects, muscles and the ligaments under loading, but also, for instance, the course of vessels or the particularities of a stump injury.

An essential element in this context for the production of a prosthesis shank for instance is a support plate which has been individually adapted to a stump extremity and which constitutes the distal end of the prosthesis shank. By means of an appropriate displacement of this support plate in proximal/distal and in ventral/dorsal direction it is possible to gradually input the volume of the functional form created by the shaped parts to allow maximal force transduction of the loaded stump end.

The contour of the upper prosthesis rim is in an interrelationship with the stump end loading from distal to proximal, because a counter brace needs to be effected through the critical cramping of the osseous relief from proximal to distal, said counter brace being adjustable through the device in a logical manner on compressed musculature by means of the shaped parts.

The support plate that has been individually fitted to the stump end is being produced as follows: a sock is pulled over the stump end and tensioned in the proximal direction. The tissue such as muscle mass etc. located at the distal end of the stump is being compressed in the proximal direction.

Over this sock, which is pre-tensioned in the proximal direction, flexible tubing is placed which completely encloses the stump with its proximal end and is fastened over the proximally placed shank entrance area of the shank of the prosthesis.

The distal end of the flexible tubing is being pulled in the distal direction by a traction plate with a centric opening which is placed in a distal extension of the stump, whereby simultaneously the stump tissue that is being pushed in the proximal direction is being compressed in the radial direction. The tensile force is in this case limited by a spring-mounted shank

The crotch space resulting between the shaped parts and the tubing can be filled with an elastic material such as a synthetic foam or silicone etc.. Under the load of the body this filling sets up precisely following the contour and thus serves as bedding for the individual bone relief and/or stump end of, for instance, a lower leg stump.

For the compressed distal stump end of a thigh stump for instance, it is also possible to make a cup enclosing the stump end which corresponds in its dimensions (diameter, height of the circumferential rim) to the existing requirements.

The advantage of the two variants described here is that the tensile forces applied to the sock or the flexible tubing respectively in the proximal and/or the distal direction as well as in the ventral and dorsal direction can be selected in such a way that a prosthesis-bearing person can evaluate the pressure resulting at the stump end during a fitting of the aid, which ensures that, with the use of the resulting distal support plate or also of a cup to be located there with a comparable loading, the contour of the distal stump end will set itself again and consequently produce a comfortable shape of the prosthesis shank for the person concerned.

In another preferred form of execution of the invention the base frame on which the shaped parts are fastened by means of the supports is fastened to a base carrier by means of at least one articulation.

In the case of a thigh prosthesis for instance this offers the possibility, by means of an articulation mounted on the hip joint axis of a prosthesis-bearing person, to rotate the resulting functional form around said axis and to bring it into positions of the bending movement of the thigh. In this manner the adaptation of the functional shape to the possibly changing distribution of mass can also be verified.

This construction feature also offers another advantage: one has actually the possibility to determine realistically a “base position”of the orthopedic aid. For this, one needs to be aware that for instance the base position of a thigh stump does not follow an essentially vertical line as it does with a healthy leg, but is raised forward for instance, due to unbalanced muscular forces. If a prosthesis is created for such a thigh stump with an essentially vertical course of the stump receptacle, when the prosthesis bearer is making steps and because of shortened muscles, the pelvis and the lumbar vertebra are painfully tilted forward (in the ventral direction) which can produce a corresponding loading of the spinal column. But the device provided here permits to determine the optimal shank setting in the sagittal plane and thus to adjust the orientation of a prosthesis shank at the precise degree to the base position of a stump. Starting from the resulting spatial position an artificial knee joint and an artificial lower leg together with an attached artificial foot can then be joined and aligned, so that no corresponding undesirable loads of the spinal column for instance will occur.

For joining of all the substructures (knee and foot section), it is proposed to provide adapter plates that are also especially adjustable by use of the device. The purpose of these is to connect a precisely adjusted prosthesis shank as described above with previously installed horizontally oriented connection plates, in order to obtain the effects of the precisely executed adjustments in the entire structure of a prosthesis and hence to improve the entire structure of the prosthesis.

The adapter plate can thus be fastened in an essentially horizontal position to a required shank position on the prosthesis shank This applies for instance also within an element that can be filled with foam.

It is also possible to carry the supports of the shaped parts for instance by means of a kind of seesaw in a laterally pivoting manner opposite to the base support and thus to determine the position of a thigh for instance also in the frontal plane. Here it is proposed to limit the tilt from the horizontal to approximately 3° and in particular cases even to 0.5°. The goal here in particular is to be able to determine the tilt of the seesaw at the center of gravity when displacing the axis of the seesaw. The tilt of the seesaw can also be detected by electronic sensors.

Such a suspension near the hip joint opens the possibility of determining the line of force from the hip joint which is relevant for optimal positioning of add-on pieces on a prosthesis shank It is in accordance with this line of force that add-on pieces such as knee joint, lower leg and foot section are likewise positioned.

It is advantageous if the shaped parts used for the production of the functional shape for the orthopedic aid consist of transparent or semitransparent plastic such as PET for instance. Then the good fit of the orthopedic aid can also be visually well verified.

It is also possible to provide the shaped parts with pressure sensors. This offers the possibility to optimize the position of the shaped parts to each other and to the body part to be supported, while monitoring the forces applied to the body part, without having to rely on the individual perception of a prosthesis-wearing person. It is hence also possible to perform measurements under realistic conditions directly on the body. The forces can be detected electronically on the movable shaped parts as well as on the independent carrier devices, for instance on the ramus layout or tuber bank and/or the fixable lower shaped part of the distal stump enclosure which is independent thereof. The alteration of the functional shape on the body, in accord with the patient's sensations and the actual monitored pressure load can now be realized for the first time.

In order to shape an orthopedic aid such as a prosthesis shank or an orthesis, it is being proposed to beef up the body part to be molded with a spacer like a uniformly thick coating, for instance with bandages, socks, special fabric hoses, silicone liners etc. The body part that has been beefed up appropriately with a uniform spacer is provided with most of the interconnected shaped parts, and these are (also) moved in their positions by means of the supports and modified until their position is not only felt to be comfortable by the prosthesis wearer but also meets the orthopedic requirements, like for instance a uniform plane fit or a space allowance in desired areas.

At the end of this fitting process the shaped parts are fixed by fastening of the supports in their determined positions and the prosthesis wearer removes the body part to be molded with the spacer from the appropriately adjusted functional form. This functional form is eventually lined with a masking compound which essentially has the thickness of the spacer that is beefing up the body part to be molded.

The masking compound may advantageously be a plastic molding material, in particular a thermoplastic material that is well adaptable.

It is proposed to make this material available as a preformed cone and to then shape this cone into a rough mold. For this purpose, it is within the scope of the invention to connect an appropriate cone (with or without integrated functional parts) to an appropriate device for heating and deformation.

The resulting rough mold of masking compound, i.e. especially of plastic material can finally be taken out of the functional mold and constitutes either the desired orthopedic aid itself or serves as basic element for its production. Either the resulting rough mold is being processed into a prosthesis for instance by attaching appropriate add-on pieces to it or by applying additional desired padding in critical places. But alternatively, the rough mold can also be used to produce the positive model of a stump under load or of another body part with which a prosthesis shank is then constructed in the traditional manner.

In order to obtain as smooth an inner surface as possible during the lining of the functional form with plastic material, it is suggested to use a thermoplastic material which is in particular pushed towards the exterior by a balloon acting on it from the inside. But it is also possible to inflate the plastic material without a separate aid. It is furthermore suggested to supply the thermoplastic material in several layers bonding to each other. Between these layers it is possible to apply elastic bolstering masses etc. which permit a precise fitting of an orthopedic aid.

It is furthermore within the scope of the invention, if by means of controlled thermoplastic heating, a functioning part, as for instance a valve, is inserted into the plastic material at any desired location.

### BRIEF DESCRIPTION OF THE SEVERAL VIEWS OF THE DRAWINGS

Additional advantages and features of the invention become evident from the following descriptions of examples of execution.

FIG. 1 shows the side elevation view of a device according to the invention.

FIG. 2 shows the top plan view of a device according to the invention as per FIG. 1.

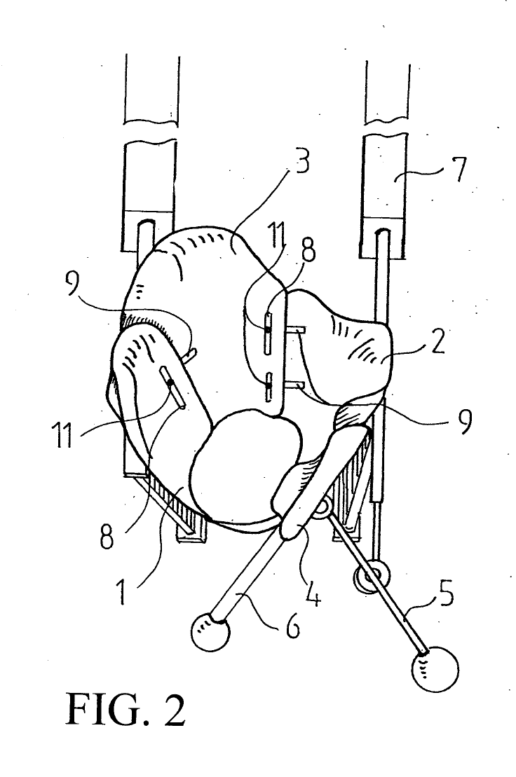

FIG. 3 shows a perspective view of a representation of two shaped parts that are to be connected.

FIG. 4 shows the schematic view of the fixation of a shaped part to a support.

FIG. 5 shows a schematic view of the the connection between shaped part and support as per FIG. 4 in a section.

FIG. 6 shows a side elevation view of individual supports and elements for adjustment.

FIGS. 7a and 7b show elevation views of a basic support in a front elevation and a side elevation view.

FIG. 8 shows a sectional view through a special shaped part for use as ramus layout.

FIG. 9 shows a sectional view through a device for the production of an individual support plate with electronic force sensors.

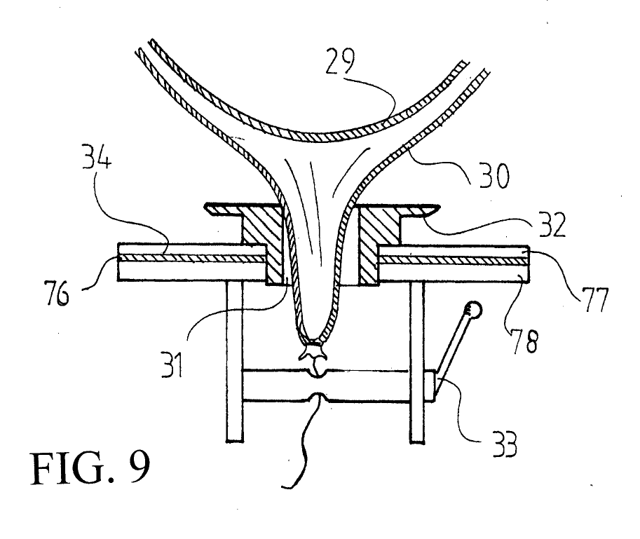

FIG. 10 shows a cross-sectional view of a device for the thermoplastic deformation of a plastic funnel with a balloon.

FIG. 11 shows a schematic view for the production of a corset as example for an orthesis.

FIG. 12 shows a sectional view through a device for the thermoplastic deformation of a plastic funnel.

FIG. 13 shows a detailed schematic view for a seesaw bearing with electronic sensors.

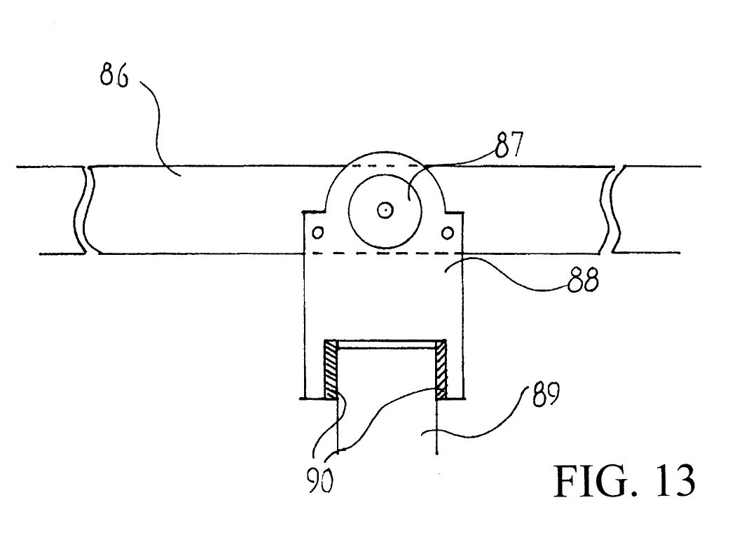

FIG. 14 shows a schematic view of a fabric structure of a preferred material for a spacer coating.

FIG. 15 shows an elevation view of the section through the adapter plate and a counter plate with a container for polyurethane foam.

FIG. 16 shows a section through an insertion device for a valve seat.

### DETAILED DESCRIPTION OF THE INVENTION

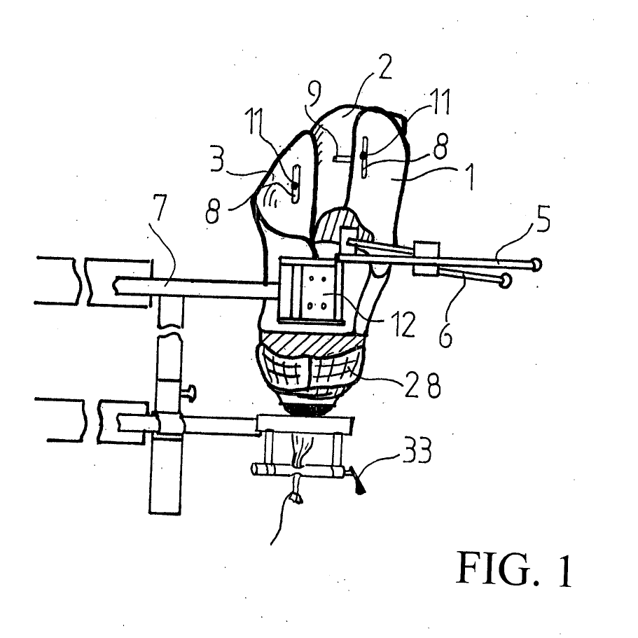

In FIG. 1, one recognizes a device for the production of an individually fitted orthopedic aid, in this case of a prosthesis shank for a thigh.

One recognizes a plurality of shaped parts 1, 2, 3, 4 which are fastened by supports 5, 6 to a base frame 7.

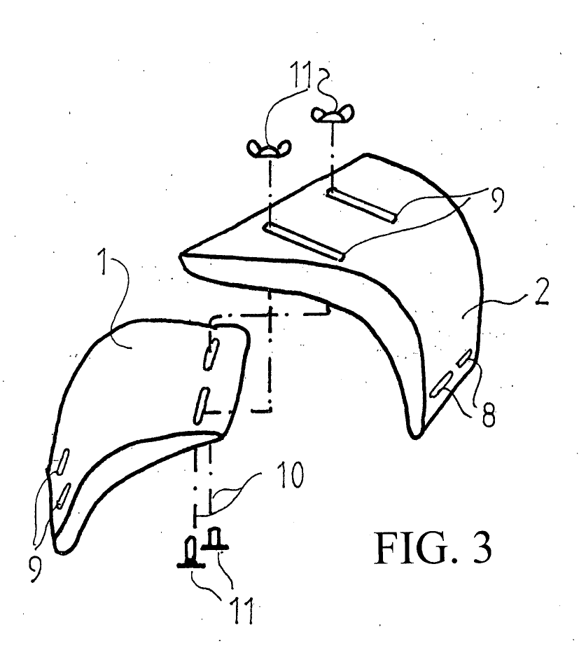

In their border areas, the individual shaped parts, two of which are shown in FIG. 3, feature oblong holes 8, 9 which together comprise an approximate angle of 90°. Connecting screws can be threaded through paired corresponding oblong holes along the dot-dash lines as per FIG. 3. This construction makes it possible to shift the individual shaped parts connected to each other in all directions of a plane.

The individual shaped parts are made of a deformable, thermoplastic material in particular, such as PET for instance. They are capable to be twisted and to bend etc. through exterior forces applied to them. At the same time, it is ensured that the individual shaped parts on their interior surface transition as uniformly as possible and without the formation of a possible step into an adjacent shaped part.

The shaped parts described here make it possible to fit a functional form with precise contours to a thigh stump under a load deforming it and thus to simulate an interior surface of a prosthesis shank to be formed after it which eventually will correspond optimally not only to the thigh stump, but also to the prosthesis components to be adapted to the prosthesis shank.

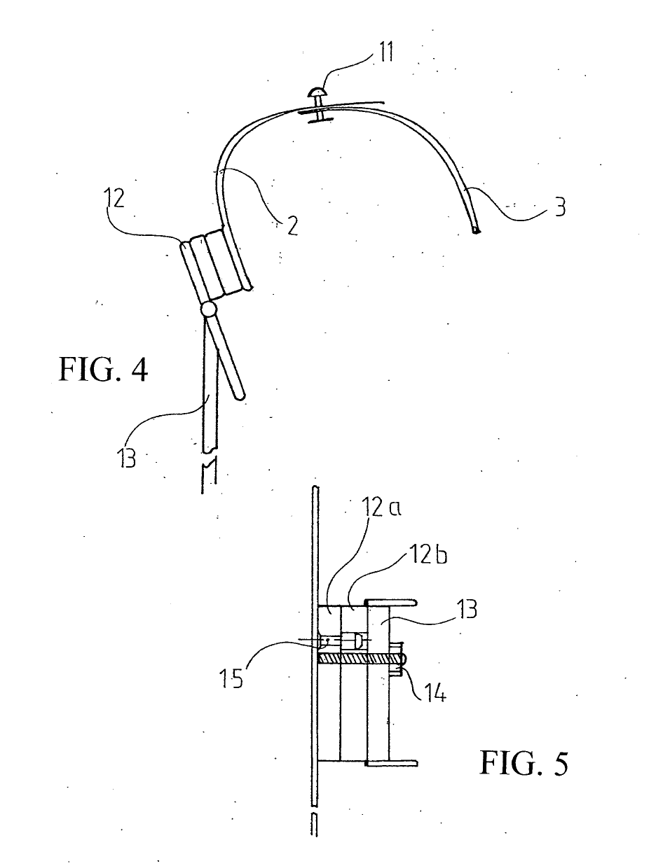

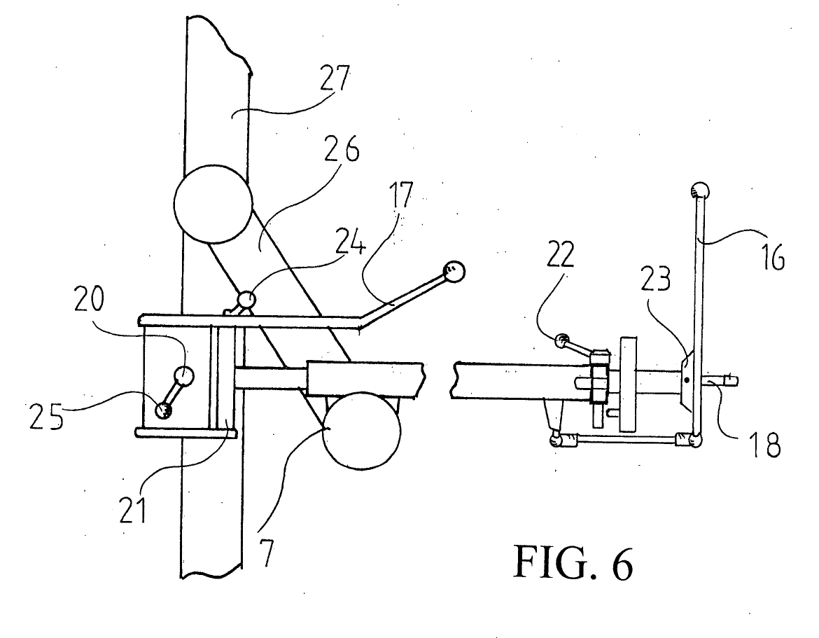

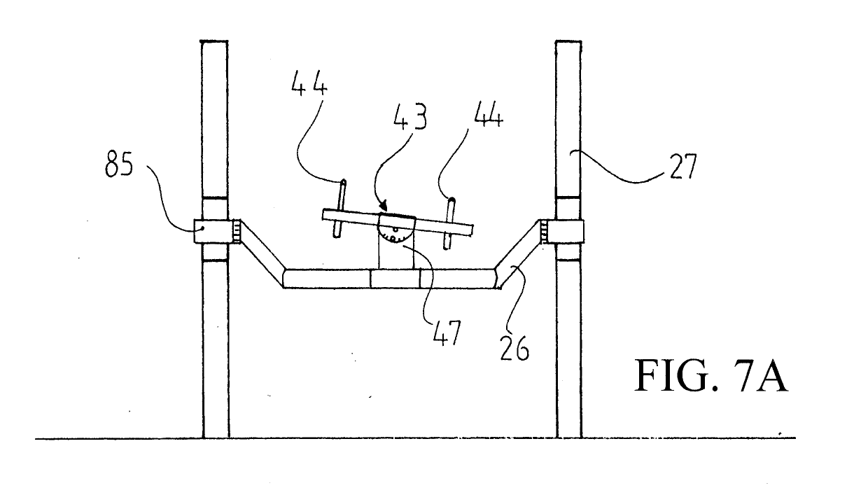

The individual shaped parts are, as shown in FIGS. 4 and 5, connected over intermediate elements 12 to the corresponding supports 13. The intermediate elements contain plates 12a, 12b, which are adjustable against each other, while being able to be fastened against each other by appropriate tensioning screws 14 or fixing devices 15 in any position to each other. It is hence possible, by means of appropriate levers 16, 17, as shown in FIG. 6, to apply forces over guide rods 18 or pressure bars 19 to push them forward or backwards, or even to rotate them around a pivot 20 or an axis 21, thus fitting the shaped form in an optimal manner to a leg stump. The shaped form being transparent or translucent, it is possible to visually verify the fit of the stump to the surface formed by the shaped parts.

The individual plates, pivots, axes etc. may also be provided with markings, scales or may be connected by sensors to electronic measuring instruments on which the adjustments that have been performed can be read or stored. In this manner, it is also possible to reproduce any adjustments, if necessary.

Positions, in which the person to be fitted with a prosthesis a device described here, signal a comfortable position of a shaped part, and the previously modified degrees of freedom can be fixed individually by appropriate tensioning elements 22, 23, 24, 25. Over the corresponding levers 16, 17, it is possible to first apply transforming forces on the corresponding shaped parts and then the articulations etc. being in connection with the levers that can be fixed in the resulting position whereby the shaped parts are being maintained in their deformed position.

This makes it possible to remove, from the stump, the complete functional shape resulting from several shaped parts and which is taken off an existing stump under load while retaining the last shape it received. This last conserved shape does indeed respect shape alterations of the stump based on muscle or other tissue displacements occurring on it under load.

In the example represented here, the base frame 7 is additionally fastened to a base support 27 by means of a swing 26 which is part of an articulation 85. This provides the possibility to swing said functional form into several positions, especially also by the prosthesis-wearer with his existing muscles. These positions thus correspond in particular to the most diverse positions through which a prosthesis is moved during its use. One has thus the possibility to also include muscle and bone relief changes occurring on the stump during movements in considerations for the design of the prosthesis shank This also enables the user to already test the fit and comfort as long and as often as he likes prior to the actual production of the aid.

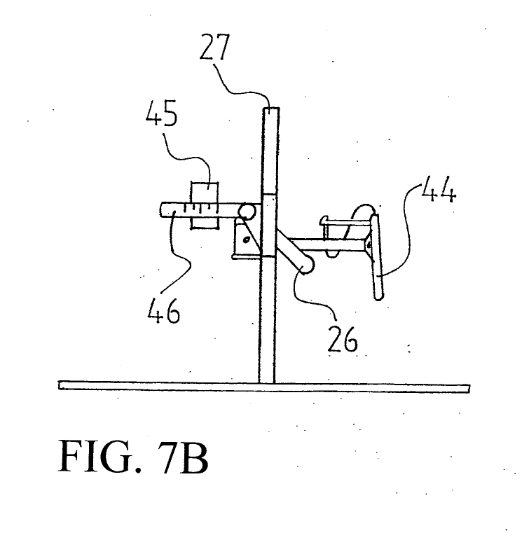

FIG. 7b shows that coupled to the shank suspensions 44 there are counterweights 45 which are movable over the guide rods 46 in order to thereby absorb the loads acting upon the shank suspensions resulting from the weight of the prosthesis-wearer etc., who supports himself over his prosthesis shank on the shank suspensions.

It is mentioned here in passing that a purposeful displacement of the counterweights 45 can also be used for therapy purposes to stretch the hip joint of a prosthesis-wearer.

FIGS. 7a and 7b also show that the base support 27 is additionally provided with a seesaw 43. On this seesaw, there are two shank suspensions 44 which are to be fastened laterally to a prosthesis shank (not shown) and which permit tilting of this prosthesis shank in the frontal plane. The swivel fixed pivot bracket 47 of the seesaw 43 is movable in the horizontal direction and thus able to laterally displace the swivel and center of motion of the seesaw in the space between the suspensions (for instance in the space of the forces entering the shank).

Through the lateral displacement, it is possible to localize the courses of the load lines on a stump or prosthesis shank respectively, thus permitting the orthopedic mechanic to optimally position add-on pieces on a prosthesis shank For the electronic capture of the center of gravity of the seesaw, it is necessary to install the bearing 87 of the seesaw 86 additionally on a pivot the bearing seat 88 of which is fixed by an abutment 89, with minimal freedom of movement between sensors 90. The sensors capture with precision the unilateral loading of the seesaw and the point of equilibrium for determining the line of force.

Added together, the possible adjustments comprise all essential features to simulate the prosthesis to be produced also as realistically as possible.

Based on the close connection addressed above of the adjacent shaped parts, any modification of a shaped parts always entails a slight modification of the other shaped parts and possibly their location relative to the stump is also slightly changed. In this way, one obtains fundamentally a fluid, optimal design of the resulting functional form.

But it is especially important, to establish an appropriate prosthesis shank in the shank entrance area, on the one hand with respect to the pelvis, especially the seat bone or the ramus ossis ischii respectively (“ramus”in the context of this application) and on the other hand with respect to the thigh bone, here especially to its apophyse located on the side of its condyle, called the trochanter major (“trochanter” in the context of this application).

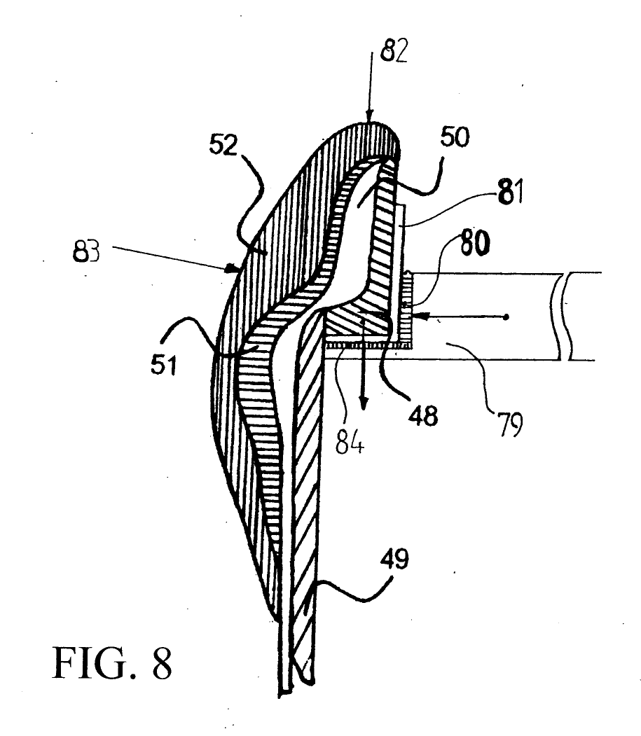

For this, provisions are made for the availability of an appropriate shaped part, e.g. a ramus layout 4 and/or an appropriate trochanter socket. These are adjustable, independent of the adjacent shaped parts 1, 2 so that a stump in the entrance area of the thigh prosthesis can be seized with great precision. A section through an appropriate ramus layout is shown in FIG. 8. This shaped part is essential for a thigh prosthesis as described here to be adaptable under load, with the previously adjusted ramus layout remaining unchanged. With an appropriate anatomically correctly shaped ramus layout, a stump can be seized very precisely in the shank entrance area. This provides also the well-fitted setting of the shank volume by means of a proximal/distal displacement of an individual distally placed support plate as described further below.

The ramus layout shown here is being provided as a separate shaped part 4 during the acceptance of a stump shape. During the subsequent formation of the functional form, this shaped part 4 will be replaced by a component 48 that is rigidly connected with an adjacent shaped part 49. As described further below, it is over this combination of the component 48 and the adjacent shaped part 49 that during the coating of the resulting functional shape a uniform lining of plastic material 50 is being applied. During the production of the final form, it is on this plastic lining that an industrially prefabricated shaped part 51, 52 is applied, the shape of which matches the shaped part 4. In this way, the plastic lining 50 is being provided with a cushion 51, 52. This ensures an optimal support in the area of the ramus layout that is free of any pressure points.

The shaped part for this ramus layout 4 can be adjusted by means of lever 6 and 5 even during a full load which makes it possible to try out the ideal pressure application of the ramus-pelotte [foam filling] even in vivo. For an electronic measurement of the pressure application of this shaped part on the human body part (ramus) sensors 80 are mounted in the horizontal direction 84 and in the vertical direction. Considering that the aforementioned modification of the frame 7 in relation to a base support 27 can also be made around several axes that are orthogonal to each other, an outward and inward sliding motion of the ramus layout generated through movement can be verified and optimized on the prosthesis wearer in a very precise and realistic manner.

In principle, the ramus layout can also be provided with an adductor support 51 forming here a unit with the ramus layout and is carried along into each position and advantageously positioned.

In this context, it is then essential to adapt the volume of the prosthesis stump to the volume of the loaded stump in order to achieve here a good fit. It is for this purpose, as can be seen in FIG. 1 that at the distal end of the prosthesis stump an individually fitted support plate is positioned which is adapted in its shape to the shape of a stump as it develops under loading. This support plate is adjustable for the volume change of the prosthesis shank in proximal/distal direction.

To generate this shape, a sock 29 is placed in proximal direction over a stump end. Due to the traction working in proximal direction the fabric at the distal end of the sock 29 is essentially dislocated proximally while forming a build-up. At the same time a traction hose 30 is placed over the sock 29 and directed through the center hole 31 of a guide plate 32. A tensioning device 33 serves to load the distal end of the traction hose 30. This has the effect of seizing and compressing the build-up forming on the stump end because of the traction by the sock 29 and the netting 14 so that the distal stump end assumes an overall compact and load-bearing shape. Through proper adjustments of the forces acting upon the sock 29 and the hose 30 and over the direction of the traction towards ventral/dorsal, sagittal/medial it is possible to achieve a shape that meets not only the comfort needs of a prosthesis-wearer but also the orthopedic requirements.

For electronic monitoring of the stump end loading, at least three sensors 76 are placed between the support plate 34 at the distal stump end and a salient support plate 77. This makes it possible to measure the shank tilt at the stump end as well as the determination of the total loading of the stump end.

A plastic material adaptable to the shapes or additionally in osseous areas, an elastic silicone or similar can be applied to the sock 29, over which eventually the shaped parts and the prefabricated in itself equally adjustable support plate 28 are installed. Such a support plate is preferably to be used on a lower leg prosthesis but also on a thigh prosthesis.

Alternatively, an orthopedic technician can also manufacture an individual cup that accepts the shape of the distal stump end. Such a cup is better suited for accepting heavier loads.

Furthermore the loading of the distal stump end can be simulated more precisely with an individual shape of the stump end cup.

The resulting functional form can then be used either for the molding of a model representing for instance the form of a loaded thigh stump.

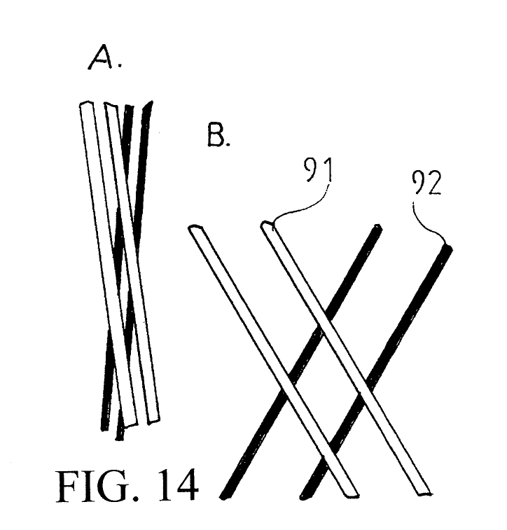

Alternatively, prior to the production of the functional form, a corresponding thigh stump can be beefed up with a distance piece, for instance through bands, socks or preferably netting 91, 92 etc., so that the resulting functional form is slightly oversized. Fabric hoses 14 are generally known and serve as a place holder for subsequently introduced material for production of the shank. A material preferred for this purpose and described hereunder, as shown in FIG. 14, for beefing up [the stump] consists of individual strands and has a thickness of at least 1 mm. The strands 91, 92 of this material run in parallel in layers and placed on top of each other with only punctual connections. During the collected bundling of the strands, this results in a minimal bundling measurement (FIG. 14) and with radial expansion in a maximal expansion measurement (FIG. 14). In the one to four superimposed layers from such strands free spaces are created which balance out every change in volume of the stump relief.

The over-dimension of the functional form can then be used to be lined with a preferably thermoplastic material for the production of a rough mold. The inside of the resulting plastic material lining or rough mold respectively then corresponds to the shape of a loaded stump that is not beefed up.

The plastic lining thus produced can be used as a rough shape to form itself the shank of a thigh prosthesis.

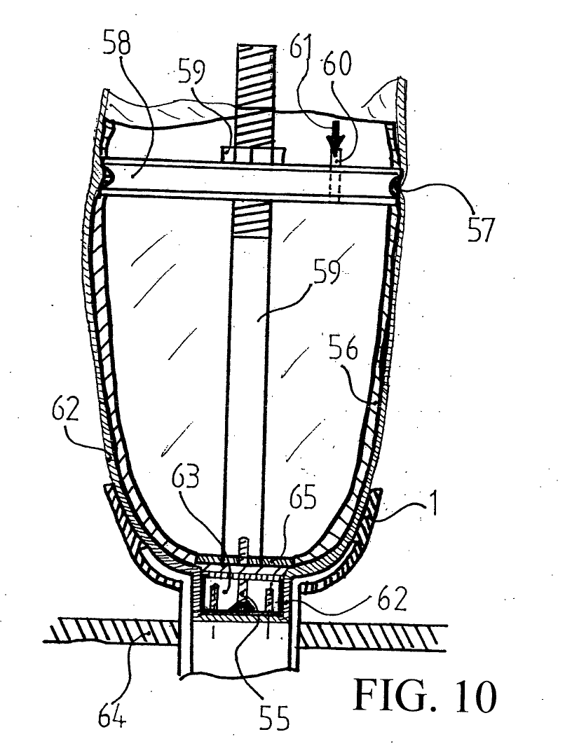

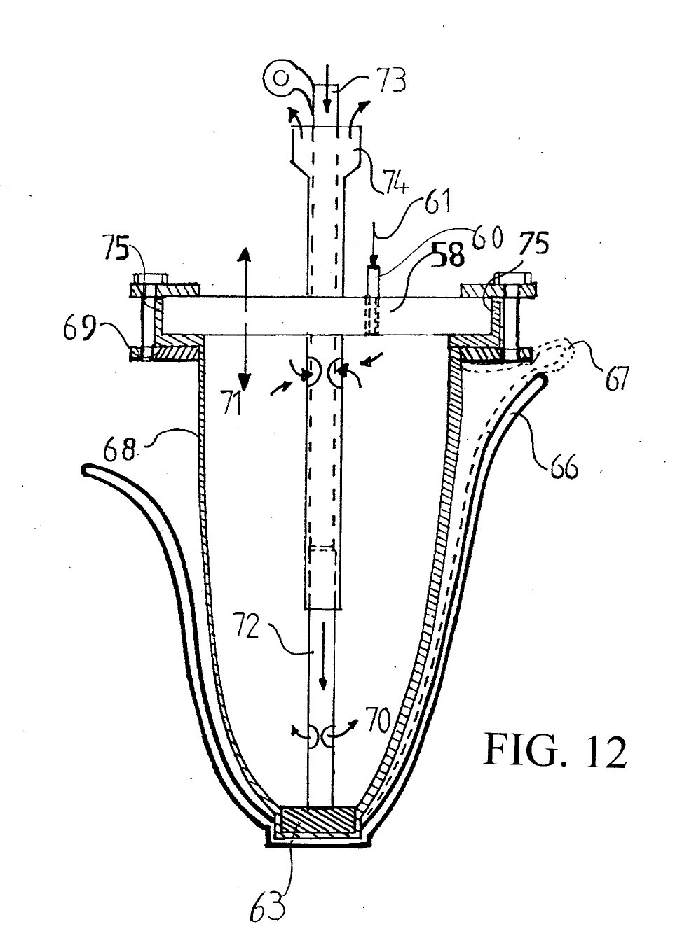

A device for installing an appropriate plastic lining or rough form respectively in the functional shape formed with individual shaped parts is shown in FIGS. 10 and 12.

One identifies a threaded rod 53 which at its lower end is provided with a plate 54 which over a screw thread 55 accepts an adapter plate for the ulterior threaded joint of knee and foot part.

Between shaped part 1 and an elastic balloon skin 56 which is made of rubber, silicone or similar material and which is expandable by at least 100%, a deformable thermoplastic material 62 is introduced. Preferably, this plastic material has already been prefabricated in a conical shape.

The balloon skin is fastened by its end that is opposite to plate 54 to a bearing disc 57 featuring a circumferential sealing groove 58. Over a threaded element 59 corresponding with the threaded bar 53 the bearing disc 57 is height-adjustable, thus making the complete length of the described device adjustable.

In the bearing disc 57, there is a valve 60 through which a pressure medium (arrow 61) can be pressed into the volume limited by the balloon skin 56.

Over a device as described here, the thermoplastic material is then placed which has been appropriately heated, or which is subsequently heated.

The device coated with this synthetic material is introduced into the functional shape, and through the valve 60 a pressure medium is pressed into the balloon skin, whereby the thermoplastic material is being pressed towards the outside and brought into adhesion with all shaped parts 1, 4 etc.

Preferably the thermoplastic material has already been prefabricated in conic form by industrial methods. The opening of the cone is compatible with the connection plate 57 of the balloon or it is hermetically screwed, as shown in FIG. 12, to the connection plate 58 (without interior balloon) with the seal 75 and the pressure plate 69. The distal end of the cone encloses the necessary connectors 63 for a liner or the prosthesis. Over the connection plate 58 the plastic cone can be heated either by streaming hot air 73 or by heating elements installed in the inner space. The plastic deformation of the heated cone occurs subsequently by incoming compressed air 61 and brings the wall of the cone, from the inside to the outside, into contact with the shaped part 66. To prevent a thinning of the cone rim, the connecting plate 58 is being tracked distally during the deformation up to the shank rim 66, to facilitate the shaping 67. That is why the inner tube 72 is executed in a mobile linear form.

The thermoplastic material is then cooled which makes it rigid in the shape that has been preset by the functional form. The resulting plastic part may then, as described above, be upholstered with individual silicone pads. It can be used as a rough form or even as a prosthetic shank or as the basis for a classic construction of a prosthetic shank

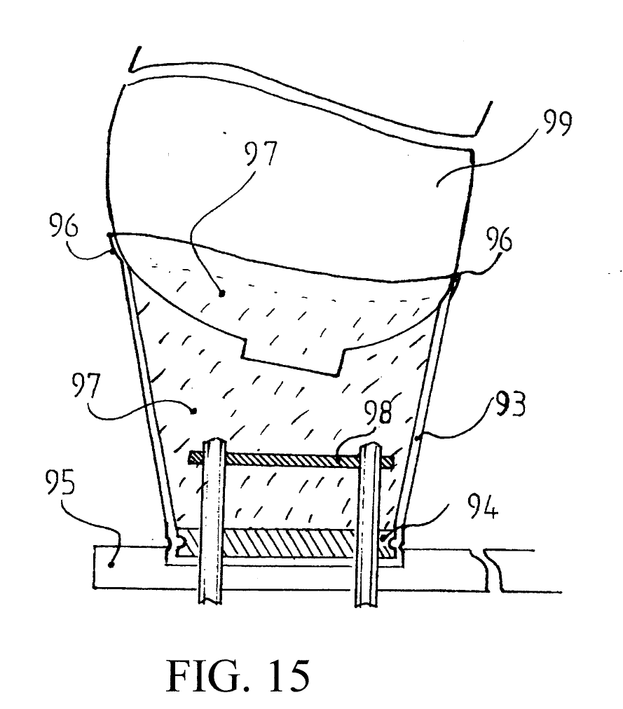

The addition of an adapter plate for the substructures of the prosthesis is shown in FIG. 15. According to the invention, the connecting plate 94 is being brought from distal to proximal in a thermoplastic deformable plastic container 93 over the stump end loading plate 95 in horizontal position by a device to the shank 99 and is being fitted positively over the thermoplastic deformable rim 96 of the plastic container to the distal shank end. In a rigid screwed connection, a vertically adjustable counter plate 98 is connected to the adapter plate 94. According to the state of the art, the hollow space inside the container 93 is being filled with poly-urethane foam and through the filling a connection is being made to the shank 99. Advantageous are here a horizontal orientation of the connecting plate 94 relative to the determined position of shank 99 in vertical and horizontal position and the shaping of the poly-urethane foam connection 97 in a sealed container. This ensures a functional position and high rigidity of the connecting plate.

For the prosthesis shank a dispenser valve is used for a vacuum adaptation of the shank on a stump. For this purpose the valve seat needs to be fitted into the shank with particular precision.

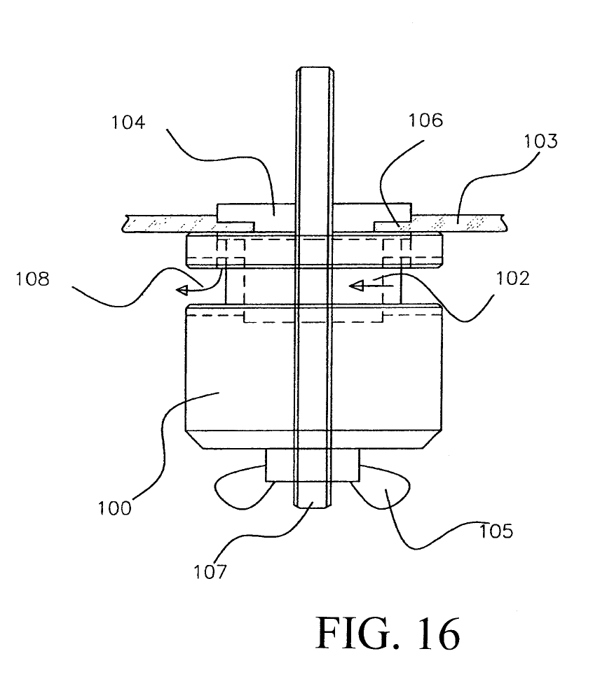

It is for this purpose that with a device 100, as shown in FIG. 16, hot air is being conducted over an inlet channel 102 toward a circular defined area for the valve seat on the thermoplastic deformable plastic cone and along the plastic material, through ejector channels located at the valve seat. The valve seat 104 that is being used is pressed into the plastic material 103 by means of a tension shaft 107 and a locknut 105 for the shaping of the plastic material 106. Since the method described here is executed without a model, this device is necessary for a precise valve seat.

Besides the shank as for instance of a thigh prosthesis as it has been described so far, it is also possible in the same manner, to produce ortheses for instance, be they seat shells or even trunk ortheses.

The production of load alleviating ortheses for the lower extremities is made according to the same principle with the same shaped parts from the leg prosthesis construction described here, but without a lower support plate as it was described above. Primarily it is the loaded joint area that is being molded where the resulting mold can then also be used for the classic construction of an orthesis.

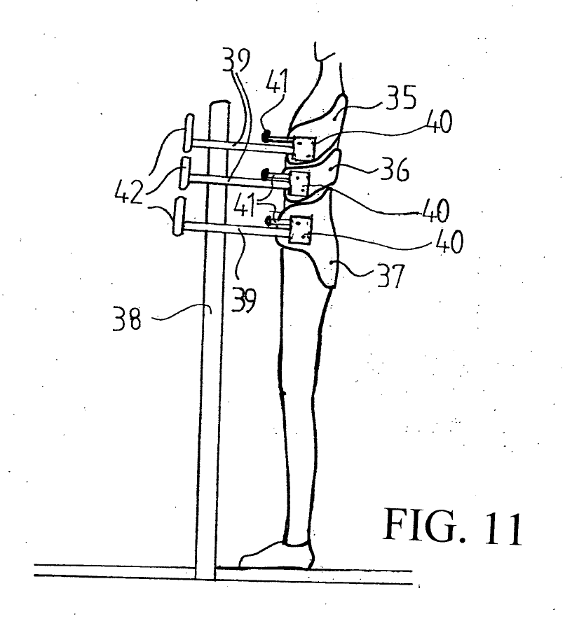

In FIG. 11, it is shown for the production of a trunk orthesis that several shaped parts 35, 36, 37 are fastened to a base support 38 by means of support 39. The individual shaped parts 35, 36, 37 and the corresponding supports 39 are interconnected by fastening elements 40 that are adjustable by levers 41/42, so that the individual shaped parts 35, 36, 37 can be adapted to the individual requirements of a person; resulting individual fitting shapes can then be determined by means of appropriate fixing levers, following the same principle as it was described above for a prosthesis shank.

In the example of execution described here, the shaped parts are likewise made of semi-flexible plastic material which permits individual adaptation to a user.

1. Device for the production of an orthopedic aid such as a prosthesis shank or an orthesis, the device comprising:
a plurality of interconnected shaped parts; and
a base frame connected to the shaped parts by supports, each shaped part being fixable in a position.

2. Device according to claim 1, wherein said supports are equipped with at least one element adjustable in at least one degree of freedom, wherein deforming forces of the supports are applied on the shaped parts.

3. Device according to claim 1, wherein the shaped parts are interconnected while being adjustable to each other.

4. Device for the production of the prosthesis shank in accordance with claim 1, wherein one of the shaped parts is an individually produced support plate fitted to a stump end, located at the distal end of the prosthesis shank, and adjusted in all directions under load.

5. Device according to claim 4, the base frame is fastened over at least one joint to a basis carrier.

6. Method for production of an orthopedic aid such as a prosthesis shank or an orthesis, the method comprising the steps of:
Applying a coating to a part to be molded,
Fitting of a number of interconnected shaped parts, fixed by supports in position relative to a base frame, to the coated part to be molded, for the creation of a functional part,
Removal of the coated part,
Lining of the functional part with a plastic material.

7. Method according to claim 6, wherein said lining is comprised of a thermoplastic material by a balloon or compressed air acting on the material from the inside.

8. Method according to claim 7, wherein said thermoplastic material is a prefabricated cone.

9. Method according to claim 8, wherein a prefabricated cone in a distal area has prosthesis components molded or attached to it.

10. (canceled)
